(19) United States
(12) Patent Application Publication
(10) Pub. No.: US 2009/0155705 A1
(43) Pub. Date: Jun. 18, 2009

(54) Release Agent Formulation for Chemically Prepared Toner

(76) Inventors: Rick Owen Jones, Berthoud, CO (US); Lale Gokbudak Lovell, Longmont, CO (US); Denise Veronica Morland, Longmont, CO (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/954,789

(22) Filed: Dec. 12, 2007

(51) Int. Cl. G03G 9/08; G03G 9/087

(52) U.S. Cl. 430/108.8; 430/137.14

(57) ABSTRACT

A method for producing toner, and a toner composition, which includes polymer binder and a release agent composition that has relatively high viscosity and associated melting characteristics that improve filming resistance and/or fusing performance. The toner may be prepared by a chemical process wherein the toner particles may be grown in an aqueous solution to obtain a desired toner particle size.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC

None.

### BACKGROUND

1. Field of the Invention

The present invention relates generally to chemically prepared toner and, more specifically, to a release agent composition that has a relatively high viscosity and associated melting characteristics that may improve filming resistance and/or fusing performance.

2. Description of the Related Art

During the electro-photographic printing process, toner may be deposited and fused onto a sheet of media. To control the toner from sticking to the fuser during the fusing process, a release agent may be utilized to aid in the release of the toner from the fuser, preventing degradation in print quality. However, during the toner formulation and fusing, the release agent may be heated to above the melting point of the release agent, allowing for the release agent to melt and migrate through the toner composition. In some cases, the release agent may migrate to the surface of the toner particles, causing what may be referred to as “bloom.” Bloom may lead to a white or hazy film on the fused toner, or may lead to filming within the electro-photographic printing devices.

### SUMMARY OF THE INVENTION

In a first exemplary embodiment, the present disclosure relates to a method of producing toner comprising forming an aqueous dispersion comprising polymer binder including a release agent and a stabilizing agent, wherein the polymer binder has a glass transition temperature (Tg) and the release agent has both a viscosity of at least 40 mPa*s at 120° C. over a shear range of 300 sec⁻¹ to 1000 sec⁻¹ and a DSC melting range (Tmᵣ) of 40° C. to 120° C. at a heating rate of 10° C. minute. This may then be followed by heating the dispersion below the polymer binder Tg and forming aggregates of 2-25 μm and heating at a temperature above the Tg of the polymer binder and fusing together the polymer binder and release agent and forming fused particles of polymer binder and release agent.

In another exemplary embodiment, the present again disclosure relates to a method of producing toner comprising forming an aqueous dispersion comprising polymer binder having a glass transition temperature (Tg), including a release agent and a stabilizing agent, wherein the release agent has a viscosity of at least 40 mPa*s at 120° C. over a shear range of 300 sec⁻¹ to 1000 sec⁻¹, a DSC melting range (Tmᵣ) of 40° C. to 120° C. at a heating rate of 10° C. minute and a DSC peak endothermic melting temperature (Tmₚ) of 65° C. to 105° C. at a heating rate of 10° C. minute. This may then be followed by adjusting pH and heating the dispersion below the polymer binder Tg and forming aggregates of 2-25 μm and then again adjusting pH and ionizing the stabilizing agent and heating at a temperature above the Tg of the polymer binder and fusing together the polymer binder and release agent and forming fused particles of polymer binder and release agent.

In a still further exemplary embodiment, the present disclosure relates to a toner composition. The composition comprises polymer binder having a glass transition temperature (Tg), including a release agent, wherein the release agent has a viscosity of at least 40 mPa*s at 120° C. over a shear range of 300 sec⁻¹ to 1000 sec⁻¹ and a DSC melting range (Tmᵣ) of 40° C. to 120° C. at a heating rate of 10° C. minute and a DSC peak endothermic melting temperature (Tmₚ) of 65° C. to 105° C. at a heating rate of 10° C. minute.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is an exemplary chemical process for producing toner;

FIG. 2 is an example of rheology data of a 40 mPa*s release agent performed at 120° C. in a shear range of 300 to 1000 l/s;

FIG. 3 is an example of rheology data of an 80 mPa*s release agent performed at 120° C. in a shear range of 300 to 1000 l/s;

FIG. 4 is an example of DSC data of an 8 mPa*s comparative release agent sample;

FIG. 5 is an example of DSC data of a 40 mPa*s release agent;

FIG. 6 is an example of DSC data of an 80 mPa*s release agent;

FIG. 7 is a comparison of DSC data of the 8 mPa*s sample, the 40 mPa*s release agent and the 80 mPa*s release agent;

FIG. 8 presents scanning electron micrographs at about 5000× magnification of the toner samples 1-4 identified in Table 2; and

FIG. 9 presents scanning electron micrographs at about 5000× magnification of the toner samples 1-3 identified in Table 3.

### DETAILED DESCRIPTION

It is to be understood that the disclosure herein is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

As noted above, toner may be utilized in image forming devices to form images on media, such as paper, transparencies, etc. Devices that use toner may include printers, copiers, fax machines, etc. Generally, toner may include a binder, release agent, colorants and, optionally, additives. The binder may be a polymeric type resin, which may provide appropriate fusing characteristics when used in an electrophotographic type printer. Exemplary binders may include thermoplastic type polymers such as styrene or styrene acrylate type polymers, polyester polymers, etc. Colorants may be used herein to describe compositions that may impart color or other visual effects to toner. Colorants may include pigments, dyes or a combination thereof. The toner composition so formed may then be positioned within a toner cartridge for an image forming device such as a laser printer.

The toner compositions herein may be specifically produced by chemical processes, wherein the toner particles may be grown in an aqueous solution to obtain a desired particle size. Such growth may occur due to the process of flocculation, which may be understood herein as the process by which destabilized particles may form relatively larger aggregates.

Accordingly, a general description of a chemical process for forming toner may start with the formation of an aqueous dispersion that contains a polymer binder having a glass transition temperature (Tg) and a release agent in the presence of a stabilizing agent. Such dispersion may then be flocculated into an aggregated mixture of particles. This may then be followed by heating below the Tg of the polymer binder and forming aggregates of 2-25 microns. Such aggregates may then be heated to a temperature above the Tg of the polymer binder with fusing the polymer binder and release agent to form fused particles of polymer binder and release agent, where the particles have an outer surface. This may then be followed by cooling and recovery of toner particles.

A more specific example of a chemical process for producing toner may therefore again begin by dispersing in aqueous media, the individual constituents of the toner composition, i.e., the resin/polymer binder, release agent (wax), colorant (pigment particles), and/or charge transfer additive. Each constituent may be dispersed separately in its own aqueous environment or in one aqueous mixture as may be desired. One may then introduce stabilizing agents containing, e.g., anionic functional groups (A−), e.g. anionic surfactants and/or anionic polymeric dispersants. One may also use stabilizing agents containing cationic functional groups (C+), e.g. cationic surfactants and/or cationic polymeric dispersants. Whether prepared individually and combined, or in one aqueous medium, the constituents may then be mixed and homogenized to provide a dispersion for the preparation of toner particles. In addition, a surfactant or dispersant may be understood herein as a chemical agent that can lower the interfacial tension of a given organic and/or hydrophobic compound in an aqueous environment or assemble into aggregates (e.g. micelles).

Expanding upon the above, in the chemical manufacture of toner according to the present disclosure, polymer latexes may be prepared from the polymerization of vinyl type monomers such as styrene and acrylic in the presence of anionic type surfactants. Pigments may be milled in water along with a surfactant that has the same functionality (and ionic charge) as the surfactant employed in the polymer latex.

Release agents such as a wax (polyolefin and carnauba type) may also be prepared using a surfactant that has the same functionality (and ionic charge) as the surfactant employed in the polymer latex. Reference to polyolefin type wax herein may be understood as a hydrocarbon polymer that may include linear or branched polyalkylenes such as polyethylenes, polypropylenes, ethylene-propylene copolymers and mixtures thereof. Accordingly, such polymer may include saturated hydrocarbons of the formula CₙH₂ₙ₊₂ and/or unsaturated hydrocarbons having the formula CₙH₂ₙ. The waxes may also include synthetic waxes such as a synthetic polyolefin wax or a Fischer-Tropsch wax. The wax may be present in the toner particles in an amount by weight ranging from 1-20% based on the total weight of the toner particles. The viscosity and melting characteristics of the release agents are discussed more fully below.

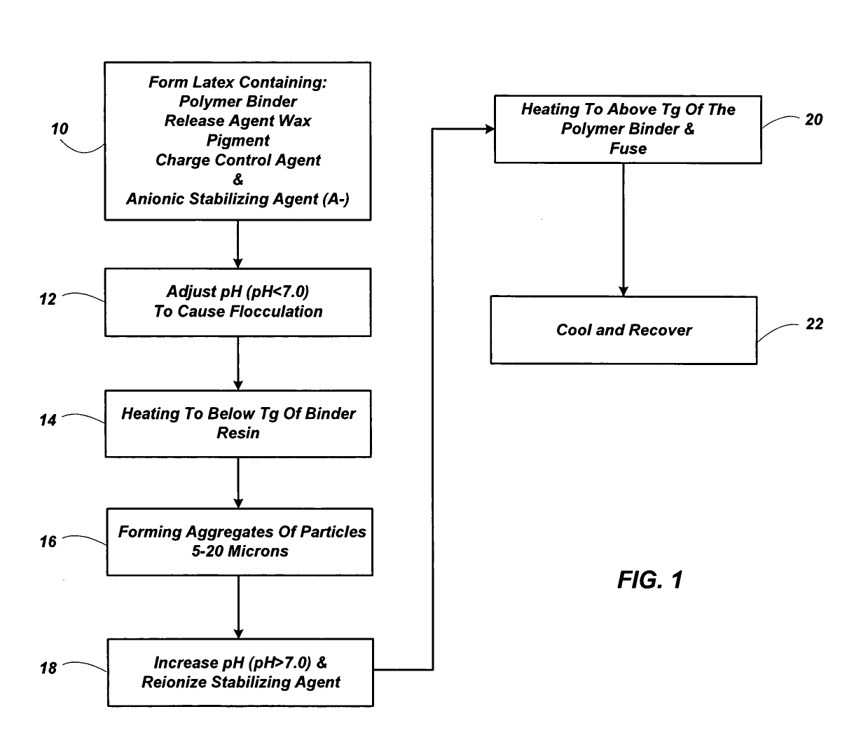

A charge control additive (CCA) may then be included. FIG. 1 now conveniently illustrates one form of CPT preparation that relies upon the initial use of an anionic stabilizing agent. As shown, the polymer latex, pigment latex, wax latex and CCA may be mixed and stirred 10 to ensure a homogenous dispersion. Acid may then be added at 12 to reduce the pH and cause flocculation. Flocculation is reference to formation of what may be described as a “gel” where resin, pigment, wax and CCA may form an aggregated mixture of particles 1-2 μm in size. The flocculated mixture may then be heated at 14 resulting in a viscosity drop. Such heating may be below the (Tg) of the polymeric binder resin. The gel may then collapse and loose (larger) aggregates, e.g., of from 2-25 μm size may be formed at 16 from the 1-2 μm particles. Base may then be added at 18 to increase the pH and reionize the surfactant/stabilizing agent or one may add additional anionic type surfactants. The temperature of the mixture may then be raised to a temperature above the Tg of the polymer binder, for example, at least about 10° C. to 70° C. above the Tg of the polymer binder, to bring about coalescence/fusing of the particles. Accordingly, coalescence is reference to fusing of all the components into toner particles. At 22, the toner particles may then be cooled and recovered.

Other exemplary methods of forming toner by chemical techniques may be found in U.S. Pat. Nos. 6,531,254; 6,531,256 and 6,991,884 whose teachings are incorporated herein by reference.

As noted above, the toners herein may include a binder. The binder may include a polymeric type resin, which may provide appropriate fusing characteristics when used in an electrophotographic type printer. The terms resin and polymer are used herein interchangeably as there is no technical difference between such descriptions. The binders may include one or more of the following: a styrene and/or substituted styrene polymer, such as homopolymer (e.g., styrene-butadiene copolymer and/or styrene-acrylic copolymer, a styrene-butyl methacrylate copolymer and/or polymers made from styrene-butyl acrylate and other acrylic monomers such as hydroxyl acrylates or hydroxyl methacrylates), polyesters, polyvinyl acetate, polyalkenes, poly(vinyl chloride), polyurethanes, polyamides, silicones, epoxy resins and phenolic resins.

The colorants referred to herein may include pigments, dyes or a combination thereof. Colorants may be understood herein to describe compositions that may impart color or visual effects to the toner. Colorants may also provide other effects in the toner, which may be detectable in non-visible regions of the spectrum, i.e., regions greater than about 750 nm and less than about 380 nm.

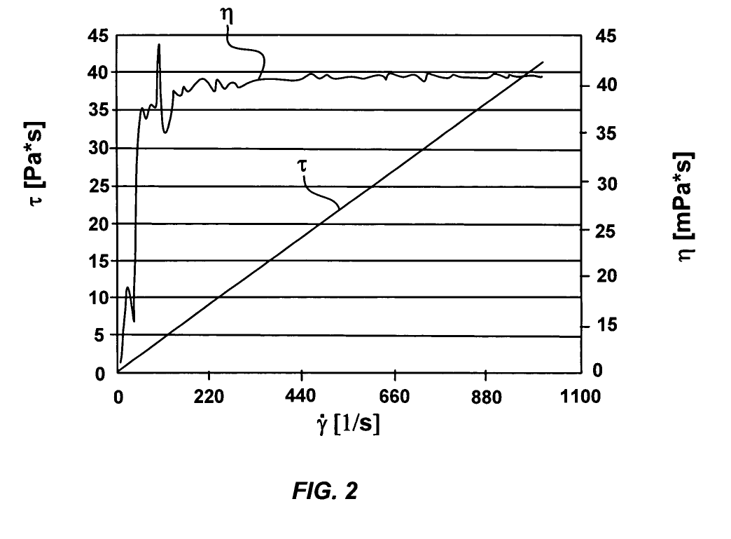

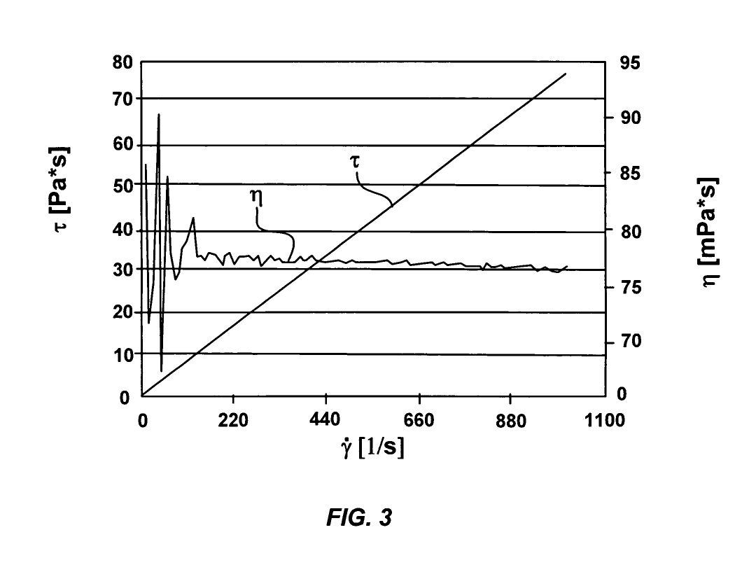

FIGS. 2 and 3 illustrate rheology data of exemplary release agents contemplated herein and the relationship between viscosity and shear rate on a Haake Torque Rheometer. More specifically, FIG. 2 illustrates an example of rheology data for a release agent having a viscosity of approximately 40 mPa*s, i.e. 40 mPa*s+/−1 mPa*s, at 120° C. over a shear rate range of 300 l/s to 1,000 l/s. As can be seen in the figure, the viscosity of the release agent appears to remain relatively stable over the measurement range. FIG. 3 illustrates another example of rheology data for a release agent having a viscosity of approximately 77 mPa*s, i.e., 77 mPa*s+/−1 mPa*s, at 120° C. over a shear rate range of 300 l/s to 1,000 l/s. As can be seen in the figure, the viscosity of this release agent also appears to remain relatively stable over the measurement range. Accordingly, the release agents herein included those which exhibit a melt viscosity of 40 mPa*s or greater at 120° C., including all values and increments in the range of 40 mPa*s to 120 mPa*s at 120° C.

In addition to the above referenced and relatively high viscosity values, the release agents herein are those which offer certain melting characteristics that may improve filming resistance and/or fusing performance. More specifically, differential scanning calorimetry (DSC) thermograms, which monitor exothermic and/or endothermic type transitions, reveal that the release agents have a peak endothermic melting temperature (Tmₚ) in the range of 65 to 105° C., including all values and increments therein, when heated at 10° C. per minute. Reference to a peak endothermic melting temperature or Tmₚ may be understood herein as the maximum in the melting endotherm over the selected temperature range. In addition, it may be appreciated that the peak endothermic melt temperature of the release agent may remain substantially similar, i.e., +/−5° C., regardless of the viscosity of the composition exhibited in the range of 40 to 120 mPa*s at 120° C.

In addition, the release agents may exhibit melting over a temperature range (Tmᵣ) which may be understood as the DSC temperature range where the melting endotherm may start (deviation from a DSC baseline) and where it may ultimately be completed. Accordingly, the temperature range observed herein for such value of Tmᵣ may be from 40° C. to 125° C., including all values and increments therein.

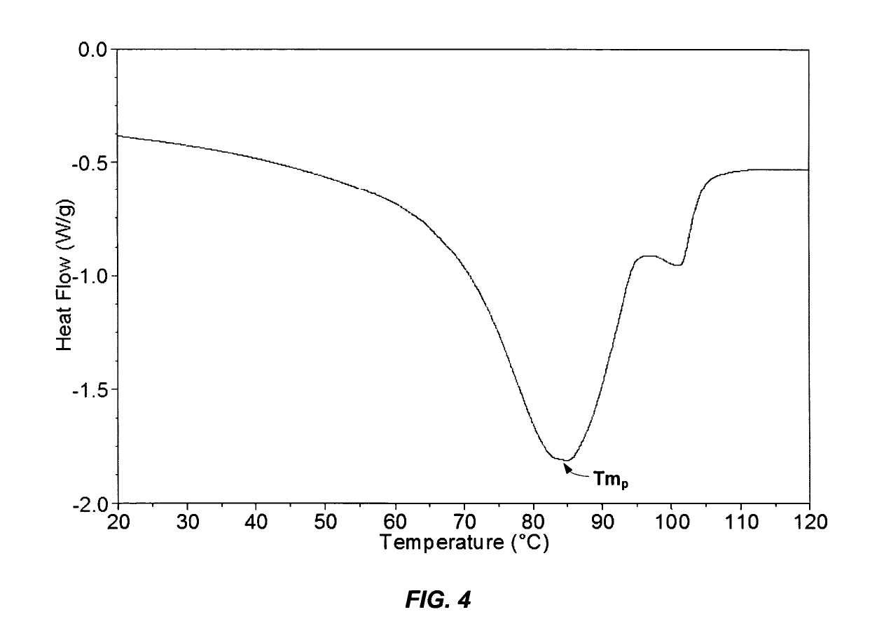

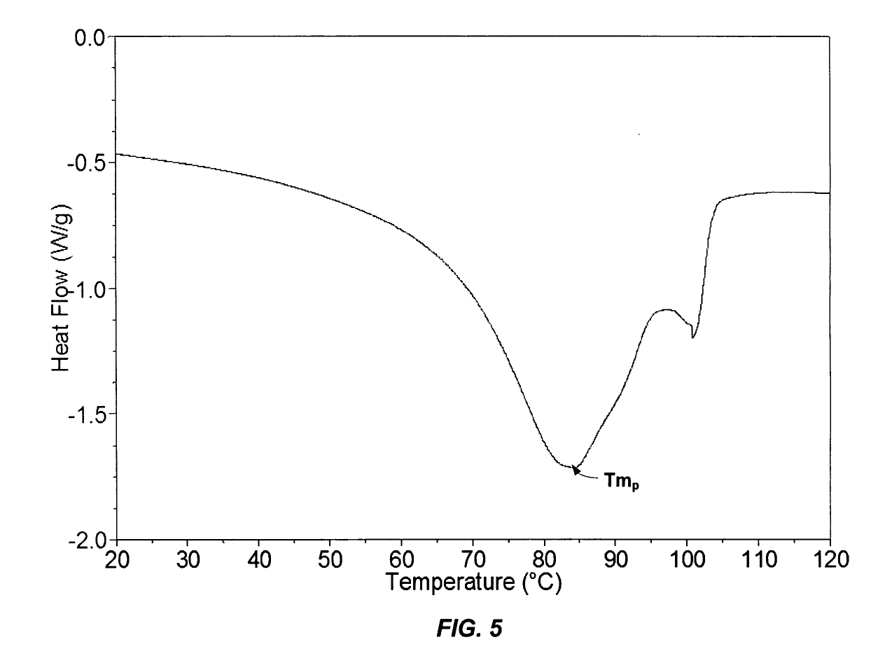

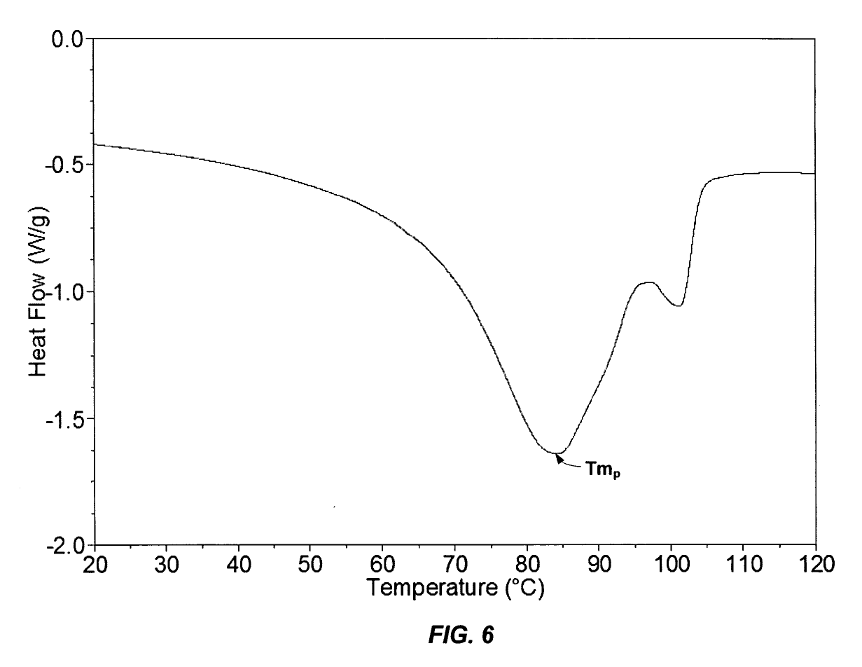

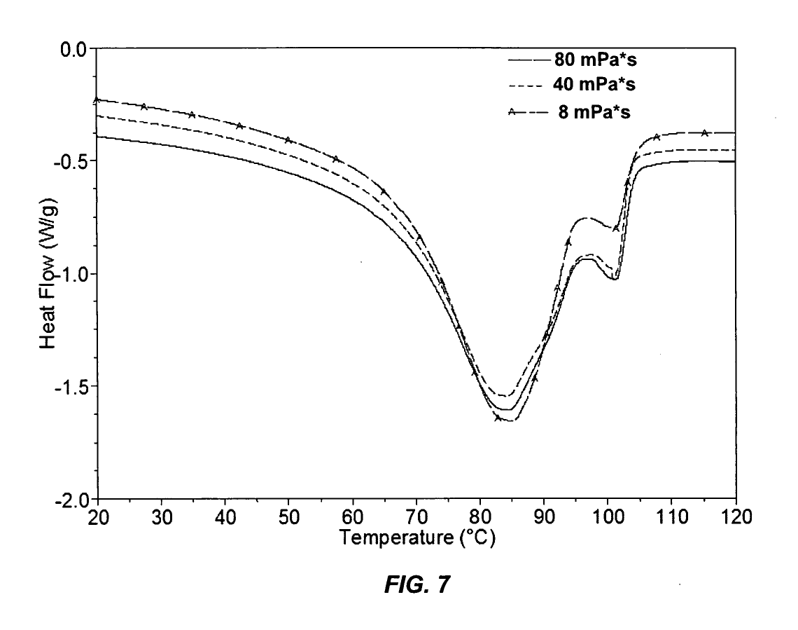

FIGS. 4-6 illustrate specific examples of differential scanning calorimetry (DSC) measurements of release agents at viscosities of approximately 8 mPa*s, 40 mPa*s and 77 mPa*s. More specifically, FIG. 4 illustrates a comparative release agent, wherein the release agent has a viscosity of 8 mPa*s. As can be seen from the DSC curve, the peak endothermic melting temperature or Tmₚ of the release agent is approximately 85° C., i.e., 85° C.+/−1° C., and the melting range of the release agent (Tmᵣ) is in the range of 47° C.+/−1° C. to 105° C.+/−1° C. FIG. 5 illustrates a release agent contemplated herein, wherein the release agent exhibits a viscosity of approximately 40 mPa*s. As can be seen from the DSC curve, the peak endothermic melting temperature or Tmₚ of the release agent is approximately 84° C., i.e., 84° C.+/−1° C., and the melting range of the release agent (Tmᵣ) is in the range of 43° C.+/−1° C. to 104° C.+/−1° C. FIG. 6 illustrates another release agent contemplated herein, wherein the release agent exhibits a viscosity of approximately 77 mPa*s. As can be seen from the DSC curve, the peak endothermic melting temperature or Tmₚ of the release agent is approximately 84° C., i.e., 84° C.+/−1° C., and the melting range of the release agent (Tmᵣ) is in the range of 51° C.+/−1° C. to 104° C.+/−1° C. An example of the release agent contemplated herein may be available from Clariant Corporation of Charlotte, N.C. under the trade name Tonerwax S105. FIG. 7 illustrates an overlay of the DSC data for the release agents exhibiting viscosities of 8 mPa*s, 40 mPa*s, and 77 mPa*s. As can be seen in the figure, the release agents appear to maintain relatively consistent values of Tmₚ and/or Tmᵣ regardless of the viscosity.

As noted above, the resulting toner formulations may include the release agent contemplated herein at a level of at least 1% by weight, including all values and increments in the range of 1% to 20% by weight of the toner solids. More particularly, the release agent may be present at a level of less than or equal to 10% by weight of the toner solids, including all values and increments in the range of 5% to 10% by weight of the toner solids.

It has been observed that the addition of the release agent contemplated herein, of the indicated viscosity characteristics, appears to reduce migration of the release agent when the toner particles are exposed to temperatures sufficient to cause the release agent to undergo melting, such as during or after coalescence and/or during the printing process. An indicator of such reduction in migration of the release agent may be confirmed by a consideration of the filming characteristics of the toner compositions in an electrophotographic device. Filming characteristics may be understood as those characteristics related to the tendency of a given toner composition to film in the electrophotographic device. Such characteristics may therefore include the amount of time for a film to develop on the doctor roll or developer roll, the amount of time before the developer roll fails due to filming.

Such filming characteristics may be measured by, for example, a filming response test. An example of a filming response test may include the use of a filming test fixture consisting of a metal framework that may allow the insertion of a developer unit in a manner and orientation that may simulate the actual mounting of the developer unit in a printer. The fixture may also include a drive motor and a gear train, which may be designed to couple with the developer unit, once it is inserted into the fixture. The motor may be adjustably controlled at a constant speed, which may duplicate the rotational speed of the developer unit in a printer. The fixture may also include three independently adjustable high voltage power supplies. Each power supply may provide a bias voltage to one of the three main components of the developer unit. The three bias voltages may include the developer roll bias, the toner adder roll bias, and the doctor (metering) blade bias. The ability to adjust the power supplies also may allow the fixture to duplicate any possible changes to those bias voltages.

A filming test may then used to assess the ability of a toner to resist filming onto the doctor blade and/or the developer roll. It is to be noted that the nature of the test utilized herein may be relatively more stressful to the toner than in actual use in a given printer. This is because there is no movement of toner out of the developer unit during such testing, as the testing procedure herein does not include a photoconductor drum in contact with the developer roller by which a toned latent image can be created. As a consequence, the relatively small quantity of toner in the toner storage area associated with the developer unit is relatively stagnant and is mechanically worked in a relatively severe manner for a number of hours. This is known to increase the relative tendency of the toner to deposit or film onto surfaces. Nevertheless, it is still a useful tool for doing comparisons of toners to gage their tendencies to film.

Filming resistance may be measured in hours to onset of filming. Each toner under test is placed in the toner storage area and run on the filming test fixture, with stops every hour to inspect for evidence of filming. Print samples are made each hour with the test cartridge, and the prints are also inspected for evidence of filming. The developer unit and print samples are compared against a sample set that was previously associated with different observed and relative levels of filming, as described below.

That is, developer roll filming may be assessed by examining the developer roller and comparing the level of filming against a reference set labeled 0 to 4 where 0 is no film and 4 is a relatively severe film on the developer roller. In particular, developer roller filming may be assessed by, e.g., evaluating the presence of film bands on the developer roller, which may be understood as filming down the horizontal axis of the roller surface. Doctor blade filming may be assessed by, e.g. examining the amount of vertical streaks present on a printed page and comparing it against a reference print sample set in which 0 is no streaks and 10 is severe streaks. When a pre-defined level of filming of the doctor blade is observed, the test may be stopped and the total elapsed time (in hours) to reach that filming level is recorded.

In addition, as alluded to above, the release agents herein provide useful fusing performance. One indicator of such fusing performance, aside from the melting temperature characteristics noted above, includes fusing toner to a number of sheets and performing abrasion tests on the fused toner. Such fusing characteristics may be measured by a fusing response test. An example of a fusing response test may include depositing toner onto sheets of media at various fusing temperatures and/or printing speeds. Rather than directly fusing the toner to the printed sheets, the toner density (i.e., the mass of toner printed over a given area,) may be calculated and/or adjusted to a desired amount. After this calibration, the unfused print samples may then be moved to a fuser, where they are fused to the paper at desired speeds and temperatures. The fuse grade of the sheets may then be determined, wherein the abrasion resistance of the fused toner on the sheets may be examined by rubbing, scratching or otherwise abrading the fused samples. Such abrasion resistance may therefore provide an indicator of the fuse grade and operating range over a given temperature range or printing speed.

### EXAMPLE 1

A number of magenta styrene/acrylic toners of various viscosities were prepared with 5% PR (pigment red) 184 in combination with 3.75% CCA (charge control agent) using an emulsion aggregation process. The release agent was added in dispersion to the emulsion aggregation process with the rest of the toner component dispersions. Table 1 illustrates the various toner formulations, wherein formulations 1 and 2 are comparative formulations.

TABLE 1

| Toner ID | Wax Type and Level |
|---|---|
| 1 | 10% 90/10 Fischer-Tropsch/Carnauba blend wax (~10 mPa*s) |
| 2 | 10% Tonerwax S105 (~8 mPa*s) |
| 3 | 10% Tonerwax S105 (~40 mPa*s) |
| 4 | 10% Tonerwax S105 (~80 mPa*s) |

Each sample formulation was finished with the same extra-particulate additive package, which included 0.5% acicular rutile titanium dioxide with an alumina oxide coating (available from ISK of CA under the product designation FTL-110), 2.0% fumed silica, approximately 40 nm in size, treated with hexamethyl disilazane —HMDS (available from Degussa Corp of NJ under the product designation RX-50), and 0.5% fumed silica, approximately 7 nm in size, treated with hexamethyl disilazane —HMDS (available from Degussa Corp of NJ under the product designation A-R812).

Once finished, the toners were run through the filming tests described above at 29 pages per minute and fusing assessment tests described below at 25 pages per minute. It is noted that the tests were performed at 29 pages per minute printing and fusing speeds over a given time period and that the developer roll, toner adder roll and doctor blade (DB) power supply bias voltages were set at −600V, −780V, and −780V. The results of these tests are shown in Table 2, wherein EOT is reference to the elapsed time at the end of testing. The fusing temperature minimum is the minimum temperature for fusing, and the fusing range is the range of temperature above the minimum fusing temperature for which fusing still is acceptably accomplished.

TABLE 2

| | | Hours to | Hours to | Hours to | DB | Dev Roll | Fusing | Fusing |
|---|---|---|---|---|---|---|---|---|
| Toner | EOT | DB | Dev. Roll | Dev. Roll | Film @ | Film @ | Tmin | Range |
| ID | (hrs) | Streaks | Film | Failure | EOT | EOT | (° C.) | (° C.) |
| 1 | 8 | 6 | 3 | 5 | 5 | 3.5 | 125 | 50 |
| 2 | 12 | 7 | 2 | 6 | 4 | 4 | 120 | 55 |
| 3 | 12 | 11 | 3 | 7 | 1 | 4 | 120 | 55 |
| 4 | 12 | None | 1 | 7 | 0 | 4 | 125 | 50 |

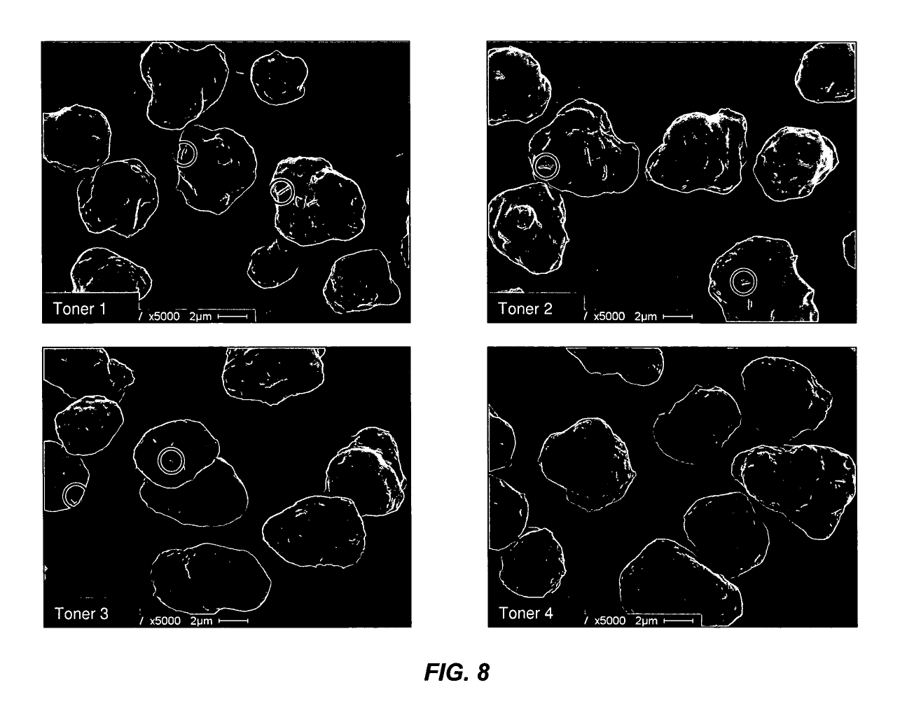

As can be seen from the above, toners 1 and 2 made with relatively low viscosity release agent showed doctor blade streaks, indicating filming of the doctor blade, after about 6-7 hours of testing. By contrast, toners 3 and 4 having relatively higher viscosity, indicated much lower levels of comparative filming during the course of testing. In addition, with respect to fusing, the relatively higher viscosity release agents here maintained fusing temperatures at desired levels, with an onset of about 120° C. and the ability to fuse at temperatures up to about 50° C. over this level. In addition to the above, and as illustrated in FIG. 8, scanning electron microscopy analysis was performed, at a magnification of about 5000×, illustrating that particles produced by toner formulations 3 and 4 exhibited relatively less and/or relatively smaller surface wax features than those made with toner formulations 1 and 2. The circled regions in the SEM photos identify surface release agent.

### EXAMPLE 2

A series of yellow styrene/acrylic toners were prepared with 6% PY (pigment yellow) 74 blended with 3.75% CCA using an emulsion aggregation process. The release agent was added in dispersion to the emulsion aggregation with the rest of the toner component dispersions. Table 3 includes the details of the toner formulations, wherein formulations 5 and 6 are comparative formulations.

TABLE 3

| Toner ID | Wax Type and Level |
|---|---|
| 5 | 10% 90/10 Fischer-Tropsch/Carnauba blend wax (~10 mPa*s) |
| 6 | 10% Tonerwax S105 with no viscosity modifier (~8 mPa*s) |
| 7 | 10% Tonerwax S105 with viscosity modifier (~40 mPa*s) |

The above toner formulations were then treated with the same additive package, including 0.5% FTL-110, 2.0% RX-50, and 0.5% A-R812. Once finished, the toners were placed in cartridges and run through the filming and fusing assessment tests described above. It is noted that the tests were performed at 25 pages per minute printing and fusing speeds and that the developer roll, toner adder roll and doctor blade power supply bias voltages were set at −600V, −780V, and −780V. The results of these tests are shown in Table 4.

TABLE 4

| | | Hours to | Hours to | Hours to | DB | Dev Roll | Fusing | Fusing |
|---|---|---|---|---|---|---|---|---|
| Toner | EOT | DB | Dev. Roll | Dev. Roll | Film @ | Film @ | Tmin | Range |
| ID | (hrs) | Streaks | Film | Failure | EOT | EOT | (° C.) | (° C.) |
| 5 | 12 | 11 | 1 | 6 | 4 | 4 | 160 | 15 |
| 6 | 11 | 8 | 1 | 5 | 10 | 4 | 165 | 10 |
| 7 | 12 | None | 1 | 5 | 0 | 4 | 165 | 10 |

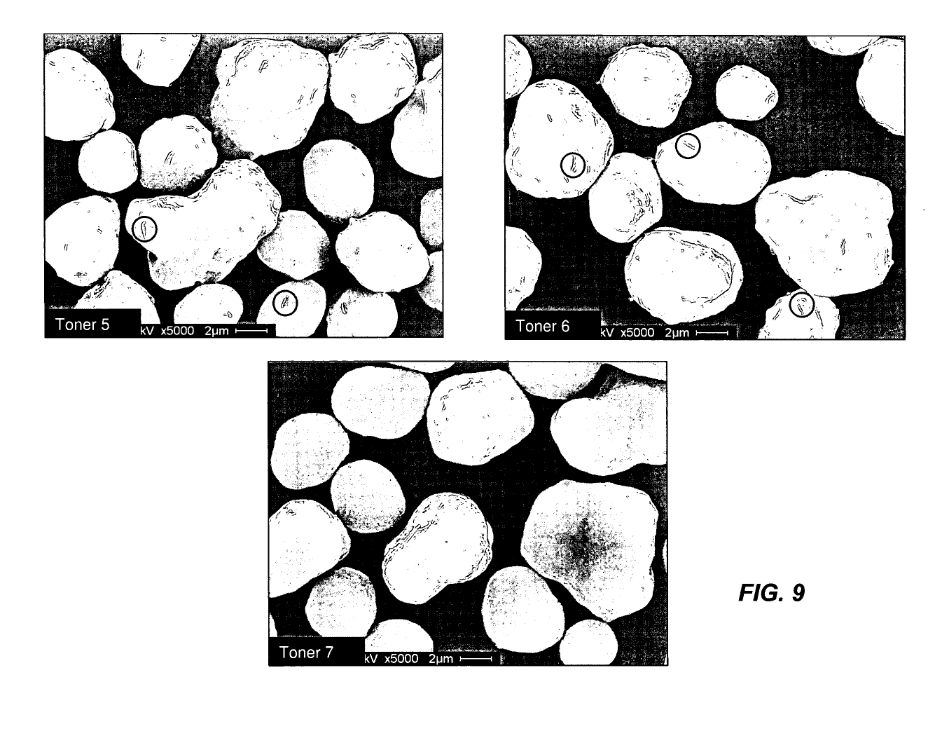

As can be seen, toner samples 5 and 6, which utilized relatively low viscosity release agents, had relatively more doctor blade filming than the toner prepared with the relatively high viscosity release agents identified herein. In addition, with respect to fusing, the relatively higher viscosity release agents here maintained fusing temperatures at desired levels, with an onset of about 160° C. and the ability to fuse at temperatures up to about 10° C. over this level. In addition to the above, and as illustrated in FIG. 9, scanning electron microscopy analysis was performed, at a magnification of about 5000×, illustrating that particles produced by toner formulation 7 exhibited relatively less and/or relatively smaller surface wax features than those made with toner formulations 5 and 6.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A method of producing toner, comprising:
(a) forming an aqueous dispersion comprising polymer binder including a release agent and a stabilizing agent, wherein the polymer binder has a glass transition temperature (Tg) and the release agent has both a viscosity of at least 40 mPa*s at 120° C. over a shear range of 300 sec⁻¹ to 1000 sec⁻¹ and a DSC melting range (Tmᵣ) of 40° C. to 120° C. at a heating rate of 10° C. minute;
(b) heating below the polymer binder Tg and forming aggregates of 2-25 μm; and
(c) heating at a temperature above the Tg of the polymer binder and fusing together the polymer binder and release agent and forming fused particles of polymer binder and release agent.

2. The method of claim 1 wherein said release agent includes a DSC peak endothermic melting temperature (Tmₚ) of 65° C. to 105° C. at a heating rate of 10° C. minute.

3. The method of claim 1 including adjusting the pH of said dispersion and flocculating into an aggregated mixture of particles.

4. The method of claim 1 including adjusting the pH prior to heating and fusing said polymer binder and release agent, wherein said pH adjustment ionizes said stabilizing agent.

5. The method of claim 1, wherein said release agent comprises a hydrocarbon.

6. The method of claim 1, wherein said release agent comprises a polyethylene polymer.

7. The method of claim 1, wherein said polymer binder comprises a styrene-acrylic resin.

8. The method of claim 1, wherein said release agent is present in said particulate at 1% to 20% by weight.

9. The method of claim 1, wherein said particles are positioned within a toner cartridge for an image forming apparatus.

10. A method of producing toner, comprising:
(a) forming an aqueous dispersion comprising polymer binder including a release agent and a stabilizing agent, wherein the polymer binder has a glass transition temperature (Tg) and the release agent has a viscosity of at least 40 mPa*s at 120° C. over a shear range of 300 sec⁻¹ to 1000 sec⁻¹, a DSC melting range (Tmᵣ) of 40° C. to 120° C. at a heating rate of 10° C. minute and a DSC peak endothermic melting temperature (Tmₚ) of 65° C. to 105° C. at a heating rate of 10° C. minute;
(b) adjusting pH and heating below the polymer binder Tg and forming aggregates of 2-25 μm; and
(c) adjusting pH and ionizing said stabilizing agent and heating at a temperature above the Tg of the polymer binder and fusing together the polymer binder and release agent and forming fused particles of polymer binder and release agent.

11. The method of claim 10 wherein said release agent comprises a hydrocarbon.

12. The method of claim 10 wherein said release agent comprises a polyethylene polymer.

13. The method of claim 10 wherein said polymer binder comprises a styrene-acrylic resin.

14. The method of claim 10 wherein said release agent is present in said particulate at 1% to 20% by weight.

15. The method of claim 10 wherein said particles are positioned within a toner cartridge for an image forming apparatus.

16. A toner composition comprising polymer binder having a glass transition temperature (Tg), including a release agent, wherein the release agent has a viscosity of at least 40 mPa*s at 120° C. over a shear range of 300 sec⁻¹ to 1000 sec⁻¹ and a DSC melting range (Tmᵣ) of 40° C. to 120° C. at a heating rate of 10° C. minute and a DSC peak endothermic melting temperature (Tmₚ) of 65° C. to 105° C. at a heating rate of 10° C. minute.

17. The toner composition of claim 16 wherein said release agent comprises a hydrocarbon.

18. The toner composition of claim 16 wherein said release agent comprises a polyethylene polymer.

19. The toner composition of claim 16 wherein said release agent is present in said toner composition at 1% to 20% by weight.

20. The toner composition of claim 16 positioned within a toner cartridge for an image forming apparatus.
